(19) United States
(12) Patent Application Publication
(10) Pub. No.: US 2010/0030408 A1
(43) Pub. Date: Feb. 4, 2010

(54) INTEGRATED INCORRECT TAKE-OFF-SETTING ALERTING SYSTEM

(75) Inventors: Ratan Khatwa, Sammamish, WA (US); Kevin J. Conner, Kent, WA (US); Yasuo Ishihara, Kirkland, WA (US)

Correspondence Address: HONEYWELL/BLG;Patent Services, 101 Columbia Road, PO Box 2245, Morristown, NJ, 07962-2245, US

(73) Assignee: HONEYWELL INTERNATIONAL, INC., Morristown, NJ (US)

(21) Appl. No.: 12/184,092

(22) Filed: Jul. 31, 2008

(51) Int. Cl. G08G 5/06; G06G 7/70; G06F 19/00

(52) U.S. Cl. 701/15

(57) ABSTRACT

A system implementable in an aircraft for generating a warning includes a processor, a first component configured to receive from a user a desired aircraft control-surface takeoff configuration, a second component configured to provide to the processor a first signal indicative of a current control-surface configuration of the aircraft, and a third component configured to provide to the processor a second signal indicative of the position of the aircraft. The processor may be configured to compare the aircraft position to the contents of a database, determine, based on the comparison, whether the aircraft is on a departure runway from which the aircraft is to depart, and generate an alarm if the aircraft is on the departure runway and the current control-surface configuration is different from the desired control-surface takeoff configuration.

### BACKGROUND OF THE INVENTION

Safety data shows that aircraft take-off with incorrect control-surface (e.g., flaps, trim, spoilers, etc.) settings has contributed to previous incidents and fatal accidents. Aircraft engaged in public transport operations are typically equipped with a take-off configuration warning horn that operates once take-off power is applied. Another approach described in commonly owned U.S. Pat. No. 7,274,308, which is hereby incorporated by reference in its entirety, provides a warning prior to takeoff that a flap configuration is incorrect, but without informing the crew members of which flap or flaps may be incorrectly positioned, whether a control surface other than flaps may be incorrectly positioned, or allowing the crew members to specifically select, from among several choices, a particular control surface configuration to which the aircraft should be subject during takeoff. Incident/accident data indicates that in some cases the nature of the problem (e.g., which control surface is incorrectly configured) was not apparent to the crew when the warning sounded.

### SUMMARY OF THE INVENTION

In an embodiment, a system implementable in an aircraft having a plurality of control surfaces for generating a warning includes a processor, a first component configured to receive from a user, or onboard database that stores acceptable range of control settings, a desired aircraft control-surface takeoff configuration, a second component configured to provide to the processor a first signal indicative of a current control-surface configuration of the aircraft, and a third component configured to provide to the processor a second signal indicative of the position of the aircraft. The processor may be configured to compare the aircraft position to the contents of a database, determine, based on the comparison, whether the aircraft is on a departure runway from which the aircraft is to depart, and generate an alarm if the aircraft is on the departure runway and the current control-surface configuration is different from the desired control-surface takeoff configuration.

### BRIEF DESCRIPTION OF THE DRAWINGS

Preferred and alternative embodiments of the present invention are described in detail below with reference to the following drawings.

FIG. 1 illustrates an exemplary system formed in accordance with an embodiment of the present invention; and

FIG. 2 illustrates a plan view of electronic depiction of aircraft control surfaces according to an embodiment of the invention.

### DETAILED DESCRIPTION OF THE PREFERRED EMBODIMENT

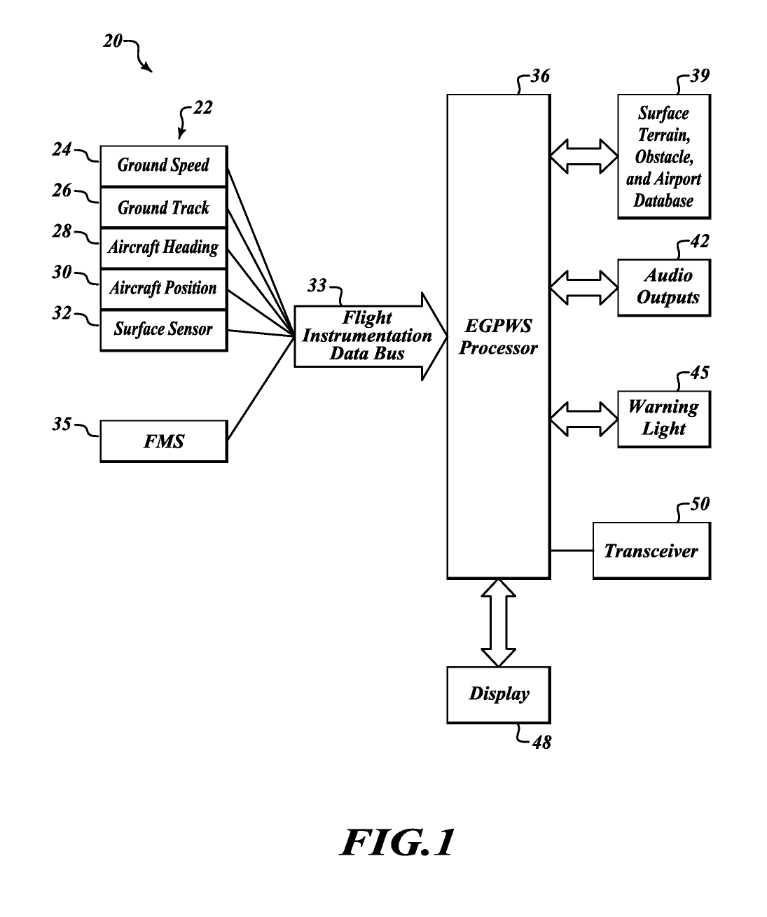

FIG. 1 indicates an enhanced ground proximity warning system (“EGPWS”) processor assembly 20, which may be onboard an aircraft (not shown), including an EGPWS processor 36 in operative communication with a database 39, the database 39 being configured to contain surface terrain, obstacle, and airport information including information as to the location and orientation of airport runways. Additionally, the EGPWS processor 36 receives information from a sensor assembly 22. By way of non-limiting example, the sensor assembly 22 may include a ground speed sensor 24, a ground track sensor 26, an aircraft heading sensor 28, and an aircraft position sensor 30. Operative communication between the EGPWS processor 36 and the sensor assembly 22 may be facilitated by a flight instrumentation data bus 33. The flight information data bus 33 may be any communicative linkage between either the sensor assembly 22 as a whole or a network of communicative links between each of the distinct sensors included in the assembly 22. The EGPWS processor 36 is configured to output information through one or more of an audio output 42, a warning light 45, and a display 48 such as a heads up display, engine indicating and crew alerting system (EICAS), and or an instrument panel configured to include a cathode ray tube or other form of video graphic display.

The sensor assembly 22 further includes a control-surface sensor 32. The control-surface sensor 32 is configured to sense the configuration of multiple types of control surfaces (e.g., flaps, trim, spoilers, etc.) and the position of each discrete part of such control surfaces.

In at least one embodiment, the EGPWS processor 36 is in operative communication with a flight management system (“FMS”). The FMS 35 may provide to the EGPWS processor 36 information relating to the anticipated flight plan that is used for azimuth and vertical profiles of operation of a commercial aircraft. The FMS 35 may also be configured to allow an aircraft crew member to select a desired control-surface takeoff configuration from a set of possible takeoff configurations. Each such configuration may include a particular combination of control surface positions suitable for a corresponding set of takeoff conditions. Additionally, the FMS 35 may be configured to allow an aircraft crew member to select from a choice of runways a particular runway from which the aircraft will depart. Alternatively, the departure runway may be wirelessly communicated to the EGPWS processor 36 from, for example, a ground traffic control facility (not shown) via a transceiver 50.

The aircraft position sensor 30 functions to derive a position of the aircraft. Non-limiting examples of an aircraft position sensor 30 include a global positioning satellite (“GPS”) receiver configured to derive an aircraft position based upon received timing signals. Other such aircraft position sensors include LORAN and other radio triangulation systems. Embodiments of the invention are not limited to devices that are autonomous within the aircraft. The aircraft position sensor 30 may also include a receiving apparatus configured to receive an aircraft position from an outside source such as a ground traffic control facility or via LAAS (Local Area Augmentation System) or WAAS (Wide Area Augmentation System).

Communicated to the EGPWS processor 36 through the flight instrumentation data bus 33, the aircraft's position is compared to the contents of the database 39 to determine if the aircraft is positioned on the runway that was specified to the FMS 35 or otherwise communicated to the EGPWS processor 36. After confirming the aircraft is positioned on the departure runway, the EGPWS processor 36 then checks the state of the aircraft control-surface configuration by communication with the control-surface sensor 32.

After receiving an indication of the current control-surface configuration from the surface sensor 32, the EGPWS processor 36 compares such current configuration with the desired control-surface configuration earlier received by the FMS 35 from a crew member. If the current configuration and desired configuration do not match, then the EGPWS processor 36 can generate an alert to flight crew that takeoff should not be attempted.

In an embodiment, the alarm may include an indication of a type of control surface causing the current control-surface configuration to differ from the desired control-surface takeoff configuration. For example, if the current flap and spoiler settings are correct as required by the desired configuration, but the trim setting is not, an aural description of the erroneously positioned trim setting (e.g., an electronically generated voice enunciating the word “trim”) may be output to the flight crew via the audio outputs 42. Alternatively, or additionally, an visual description of the erroneously positioned trim setting (e.g., an electronically generated image of the word “trim”) may be output to the flight crew via the display 48.

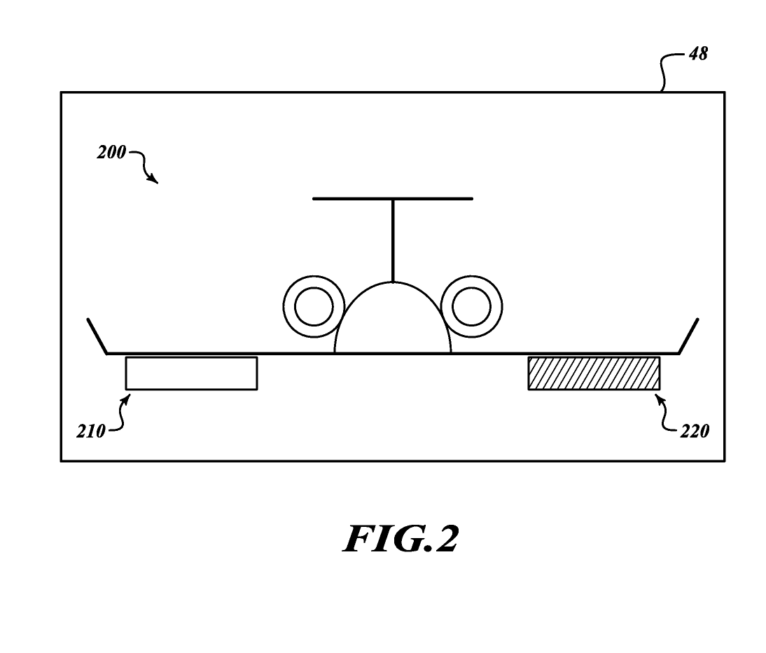

Referring to FIG. 2, in an embodiment, the EGPWS processor 36 may alternatively or additionally be configured to generate to the display 48 a detailed electronic depiction of the aircraft and its plurality of control surfaces. In the example illustrated in FIG. 2, the aircraft depiction 200 includes graphical representations of a right flap assembly 210 and a left flap assembly 220. The EGPWS processor 36 indicate the extent to which the right and left flap assemblies 210, 220 are properly positioned according to the desired control-surface configuration using contrasting presentation formats, such as, for example, color-coding or other visually distinguishing graphical techniques. If, for example, the EGPWS processor 36 determines on the departure runway that the current positioning of the right flap assembly 210 is correct according to the desired control-surface configuration, the EGPWS processor 36 can cause the right flap assembly 210 to be presented in a first format (e.g., color-coded white, as illustrated, or any other distinguishing color or format, as appropriate) to indicate that the right flap assembly is properly positioned. If the EGPWS processor 36 determines on the departure runway that the current control-surface configuration does not match the desired control-surface configuration because the left flap assembly 220 is improperly positioned, the EGPWS processor 36 can cause the left flap assembly 220 to be presented in a second format (e.g., color-coded, as illustrated in cross-hatching, or any other distinguishing color or format, as appropriate) to indicate that the left flap assembly is not properly positioned. Additionally, the EGPWS processor 36 may depict the improperly positioned left flap assembly 220 with a greater degree of granularity than is illustrated in FIG. 2. For example, if a particular flap section of left flap assembly 220 is improperly positioned, the display may present only such particular flap section in the distinguishing second format. It should be noted that, although only flap assemblies 210, 220 are illustrated and discussed with reference to FIG. 2, all other types of controls surfaces of which a control-surface takeoff configuration consists as discussed herein may likewise be similarly depicted on display 48 in contrasting formats, as appropriate.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A system implementable in an aircraft for generating a warning, the aircraft including a plurality of control surfaces, the system comprising:
a processor;
a first component configured to receive from a user a desired control-surface takeoff configuration;
a second component configured to provide to the processor a first signal indicative of a current control-surface configuration of the aircraft; and
a third component configured to provide to the processor a second signal indicative of the position of the aircraft,
wherein the processor is configured to compare the aircraft position to the contents of a database, determine, based on the comparison, whether the aircraft is on a departure runway from which the aircraft is to depart, and generate an alarm if the aircraft is on the departure runway and the current control-surface configuration is different from the desired control-surface takeoff configuration.

2. The system of claim 1 wherein the desired control-surface takeoff configuration comprises trim setting.

3. The system of claim 1 wherein the first component is further configured to receive from the user a selection of the departure runway.

4. The system of claim 1 wherein:
the plurality of control surfaces includes control surfaces of a plurality of types; and
the alarm comprises an indication of a type of control surface causing the current control-surface configuration to differ from the desired control-surface takeoff configuration.

5. The system of claim 4, wherein the alarm comprises an aural description of the type of control surface causing the current control-surface configuration to differ from the desired control-surface takeoff configuration.

6. The system of claim 1, further comprising a fourth component configured to receive a wireless signal identifying the departure runway and provide the departure-runway identification to the processor.

7. The system of claim 1, further comprising a display device configured to display representations of the plurality of control surfaces.

8. The system of claim 7 wherein the processor is configured to generate to the display device a representation in a first format of correctly configured control surfaces and a representation in a second format, different from the first format, of incorrectly configured control surfaces if the aircraft is on the departure runway and the current control-surface configuration is different from the desired control-surface takeoff configuration.

9. A system implementable in an aircraft for generating a warning, the aircraft including a plurality of control surfaces, the system comprising:
a processor;
a first component configured to provide to the processor a first signal indicative of a current control-surface configuration of the aircraft; and
a second component configured to provide to the processor a second signal indicative of the position of the aircraft; and
a display device configured to display representations of the plurality of control surfaces,
wherein the processor is configured to compare the aircraft position to the contents of a database, determine, based on the comparison, whether the aircraft is on a departure runway from which the aircraft is to depart, and, if the aircraft is on the departure runway and the current control-surface configuration is different from a desired control-surface takeoff configuration, generate to the display device a representation in a first format of correctly configured control surfaces and a representation in a second format, different from the first format, of incorrectly configured control surfaces.

10. The system of claim 9 wherein the desired control-surface takeoff configuration comprises spoiler setting.

11. The system of claim 9, further comprising a third component configured to receive from a user the desired control-surface takeoff configuration.

12. The system of claim 9, further comprising a third component configured to receive from a user a selection of the departure runway.

13. The system of claim 9 wherein:
the plurality of control surfaces includes control surfaces of a plurality of types; and
the displayed representations of the plurality of control surfaces comprise an indication of a type of control surface causing the current control-surface configuration to differ from the desired control-surface takeoff configuration.

14. The system of claim 9, further comprising a third component configured to receive a wireless signal identifying the departure runway and provide the departure-runway identification to the processor.
